(19) United States
(12) Patent Application Publication
(10) Pub. No.: US 2012/0298920 A1
(43) Pub. Date: Nov. 29, 2012

(54) METHOD FOR BIOMASS GASIFICATION IN A FLUIDIZED BED

(75) Inventors: Domenico Pavone, Bochum (DE); Ralf Abraham, Bergkamen (DE)

(73) Assignee: THYSSENKRUPP UHDE GMBH, Dortmund (DE)

(21) Appl. No.: 13/522,543

(22) PCT Filed: Dec. 31, 2010
(86) PCT No.: PCT/EP2010/008002

§ 371 Date: Jul. 17, 2012

(30) Foreign Application Priority Data
Jan. 29, 2010 (DE) 10 2010 006 192.1

(51) Int. Cl. C09K 3/00

(52) U.S. Cl. 252/372

(57) ABSTRACT

With a method for the gasification of a biomass in a fluidized bed, wherein the biomass is first pre-dried and passed to the fluidized bed gasifier, subsequently the raw gas from the gasifier impacts a recirculation cyclone and subsequently at least one raw gas cooler, the yield of such a method of procedure is supposed to be improved and the system costs are supposed to be lowered.

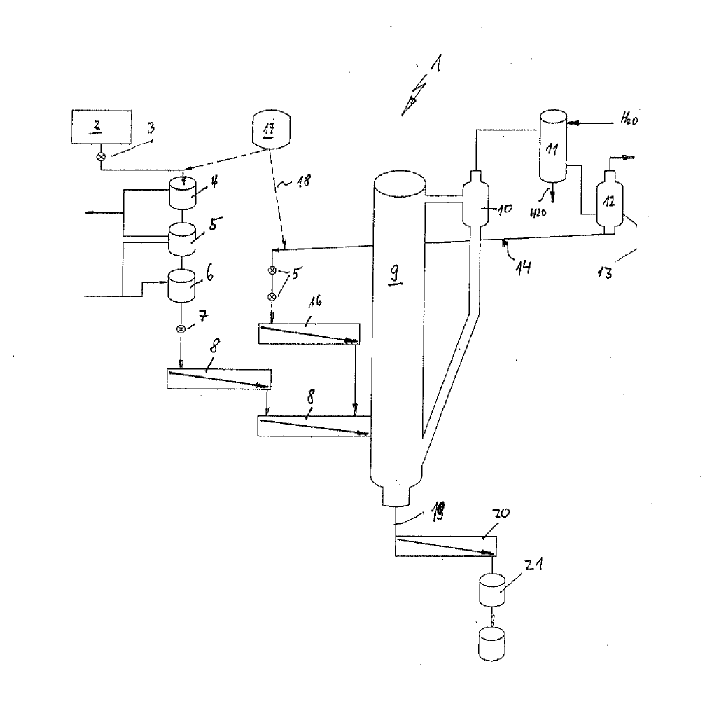

This is achieved in that the dusts that occur in the hot gas filter that follows the raw gas cooler are recirculated into the introduction system of the biomass.

The invention is directed at a method for the gasification of a biomass in a fluidized bed, whereby the biomass is first pre-dried and passed to the fluidized bed gasifier, subsequently the raw gas from the gasifier impacts a recirculation cyclone and subsequently at least one raw gas cooler.

A method of this type is known from DE 206 21 549 T2, whereby similar methods are also carried out in practice, because they are particularly well suited for energy-related biomass utilization.

A problem of the known technologies for the gasification of biomasses in a fluidized bed consists in that the C conversion is not sufficient or that it was not possible to improve it significantly, and that the removal of harmful gases such as H₂S or HCl, for example, makes additional system parts necessary.

Measurements have shown that the gasifier dust can still have C contents of 20 to 60 MA-%, so that this dust cannot be disposed of in a landfill and the dust must be subsequently treated. In general, such subsequent treatment takes place by means of combustion in a separate boiler, with the design effort and economic expenditure connected with this

This is where the invention takes its start, its task consisting of improving the yield of such a method of procedure and lowering system costs.

With a method of the type indicated initially, this task is accomplished, according to the invention, in that the dusts that occur in the hot gas filter that follows the raw gas cooler are recirculated into the introduction system of the biomass. By means of this recirculation, a clear improvement in the C conversion in the gasification of biomass is achieved.

Embodiments of the invention are evident from the dependent claims. For example, it can be provided according to the invention, in one embodiment, that the recirculation of the dusts is undertaken by way of gravity feed and/or by way of screw conveyors, two possibilities that can be implemented easily and efficiently.

It can be practical to pass the recirculated dusts by way of cell wheel locks, as the invention also provides, in one embodiment.

In order to avoid an increase in concentration of the bottom product of the gasifier, it can be provided to extract dust from a dust silo that follows the hot gas filter.

It is practical that furthermore, it can be provided that sorption agents are fed in to precipitate harmful gases, such as, for example, H₂S, HCl, whereby in a further embodiment, it can be provided that the sorption agents are metered in from a silo, by means of a lock system.

In a particular embodiment, it is provided that the sorption agents are circulated separately until saturation of raw gas, together with the dust, takes place in the hot gas filter.

Finally, the invention also provides that additives are fed in, in a weighing container or by means of metering into a conveyor screw, whereby additives that are used are, for example, iron ore, calcium carbonate, calcium oxide, calcium hydroxide, dolomite, or the like.

Other advantages, characteristics, and details of the invention are evident on the basis of the following description and using the drawing. This shows, in the single FIGURE, a system schematic for implementation of the method of procedure according to the invention.

The system for gasification of a biomass in a fluidized bed layer, indicated in general with 1, is formed essentially by the system elements described below:

In this connection, a wood-drying and storage unit is indicated with 2, whereby the material to be processed is first passed, by way of a lock system, for example a cell wheel lock 3, to a weighing container 4, subsequently to an introduction lock system 5, and finally to a supply container 6.

The material from the supply container 6 is then passed, again by way of a cell wheel lock 7 and at least one screw 8 (in the example shown, two screws 8 are shown), to the gasifier 9, and gasified there. The gas is passed to a recirculation cyclone 10, and from there finally passed to a raw gas cooler 11 and, by way of a hot gas filter 12, to further use.

In the system schematic, a dust silo for partial withdrawal of the dust is also shown behind the hot gas filter 12, whereby the dust silo is indicated with 13. The dust recirculation line, indicated in general with 14, is essential, by means of which the dust can be recirculated to the gasifier from the hot gas filter, by means of gravity, whereby the product is guided by way of cell wheel locks 15 and another screw 16, for example.

Finally, a silo for additives is indicated with 17; the possible feed lines are shown with broken lines and indicated with 18.

Finally, a bottom discharge from the gasifier 9 is indicated with 19, whereby the products that occur there are in turn passed to the corresponding accommodations 21 by way of a screw 20.

Of course, the exemplary embodiment of the invention as described can still be modified in many different aspects, without departing from the basic idea of the invention, in particular as far as the recirculation of the dust from the hot gas filter 12 is concerned; generally, cartridge filters are used in this filter, to separate the dust.

1-9. (canceled)

10. Method for the gasification of a biomass in a fluidized bed, wherein the biomass is first pre-dried and passed to the fluidized bed gasifier, subsequently the raw gas from the gasifier impacts a recirculation cyclone and subsequently at least one raw gas cooler,
wherein
the dusts that occur in the hot gas filter (12) that follows the raw gas cooler (11) are recirculated into the introduction system of the biomass (Line 14) and for precipitation of harmful gases, such as H₂S, HCl, for example, sorption agents are fed in.

11. Method according to claim 10,
wherein
the recirculation of the dusts is undertaken by way of gravity feed and/or by way of screw conveyors.

12. Method according to claim 10,
wherein
the recirculated dusts are guided by way of cell wheel locks.

13. Method according to claim 10,
wherein
in order to avoid an increase in concentration of the bottom product of the gasifier, dust is withdrawn from a dust silo that follows the hot gas filter.

14. Method according to claim 10,
wherein
the sorption agents are metered in from a silo, by means of a lock system.

15. Method according to claim 10,
wherein
the sorption agents are circulated separately until saturation of raw gas, together with the dust, takes place in the hot gas filter.

16. Method according to claim 10,
wherein
additives are fed in, in a weighing container or by means of metering into a conveyor screw.

17. Method according to claim 10,
wherein
additives that are used are, for example, iron ore, calcium carbonate, calcium oxide, calcium hydroxide, dolomite, or the like.
